(19) United States
(12) Patent Application Publication
(10) Pub. No.: US 2022/0106175 A1
(43) Pub. Date: Apr. 7, 2022

(54) OPERATION CONTROL DEVICE FOR VEHICLE WITH AN AERIAL WORK PLATFORM

(71) Applicant: KABUSHIKI KAISHA AICHI CORPORATION, Saitama (JP)

(72) Inventor: Takuya AOKI, Hasuda-shi (JP)

(73) Assignee: KABUSHIKI KAISHA AICHI CORPORATION, Saitama (JP)

(21) Appl. No.: 17/460,081

(22) Filed: Aug. 27, 2021

(30) Foreign Application Priority Data
Oct. 2, 2020 (JP) 2020-167524

(51) Int. Cl. B66F 17/00; B66F 11/04

(52) U.S. Cl. CPC B66F 17/006; B66F 11/046

(57) ABSTRACT

An operation control device for a vehicle with an aerial work platform comprises a vehicle body (3), a boom (5) provided on the vehicle body so as to be capable of rotating, vertically swinging, and extending and contracting, a work platform (8) provided at the tip of the boom, an operation device for operating the boom, an operation control device (9) for controlling rotating, vertically swinging, and extending and contracting the boom based on an operation signal from the operation device, a designation device for designating an allowable work range of the work platform, and an operation preventing device for preventing the operation of the boom by the operation control device so that the work platform does not exceed an allowable work range designated by the designation device.

### TECHNICAL FIELD

The present invention relates to an operation control device for a vehicle with an aerial work platform for controlling the operation of a boom provided in the vehicle with an aerial work platform.

### TECHNICAL BACKGROUND

A vehicle with an aerial work platform, which is used for working at a height for activities such as electric installation work or construction work, is generally provided with a turntable that is rotatable on a freely movable vehicle body, a boom that is freely vertically swingable and axially extendable relative to the turntable, and a work platform which is attached so as to be swingable to the tip of the boom and on which an operator is on board. The vehicle with an aerial work platform is also provided with an operation device for operating the movement of the turntable, the boom, and the like, and a work control device for controlling the operation of the turntable, the boom, and the like, wherein the work control device controls the operation of various actuators for operating the turntable, the boom, and the like in accordance with various operation signals output from the operation device, thereby controlling the rotating operation of the turntable, the vertically swinging operation and axially extending operation of the boom, the swinging operation of the work platform, and the like.

Some of the vehicles with an aerial work platform described above are equipped with a safety device that detects the position of the boom tip or work platform and compares it with a predetermined allowable work range and prevents the operation of the boom if it exceeds the allowable work range. For example, the vehicle with an aerial work platform described in Japanese Laid-Open Patent Publication No. 2004-175561(A) is configured in such a manner that a controller for operating a boom or a rotating body according to an operation signal corresponding to an operation amount of an operation lever is provided with a storage unit for storing allowable work range data for each swing posture of the boom, and when it is determined that the tip of the boom has reached the limit of the allowable work range by comparing the current position of the tip of the boom and the allowable work range data corresponding to the swing posture of the boom, the operation signal exceeding the allowable work range is ignored.

### SUMMARY OF THE INVENTION

### Problems to be Solved by the Invention

In general, since the height from the ground to the work object above the ground often varies depending on the worksite, such as electric installation work or construction work, the allowable work range described above also varies depending on the worksite in many cases. However, since the allowable work range in the prior art is set in advance to prevent a vehicle from falling over, it may not be suitable for the allowable work range in an actual worksite.

It is an object of the present invention to provide an operation control device for a vehicle with an aerial work platform capable of setting an appropriate allowable work range in an actual worksite.

### Means to Solve the Problems

In order to achieve such an object, an operation control device for a vehicle with an aerial work platform according to the present invention comprises a vehicle body (for example, the vehicle body 3 in the embodiment), a boom (for example, the boom 5 in the embodiment) provided on the vehicle body so as to be capable of rotating, vertically swinging, and extending and contracting, a work platform (for example, the work platform 8 in the embodiment) provided at the tip of the boom, an operation device (for example, the upper operation device 9 in the embodiment) for operating the boom, an operation control device (for example, the control unit 30 in the embodiment) for controlling rotating, vertical swinging, and extending and contracting the boom based on an operation signal from the operation device, a designation device (for example, the prevention range setting screen and the prevention position setting switch 91 in the embodiment) for designating an allowable work range of the work platform, and an operation preventing device (for example, the control unit 30 and the work range memory 31 in the embodiment) for preventing the operation of the boom by the operation control device so that the work platform does not exceed an allowable work range designated by the designation device.

In the operation control device of the vehicle with an aerial work platform described above, preferably the designation device can designate the allowable work range by a height from the ground to the work platform (for example, a height H in the embodiment) and a horizontal distance (for example, a working radius R in the embodiment) which is a turning radius from a turning center axis of the boom to the work platform.

The operation control device for a vehicle with an aerial work platform described above preferably comprises an allowable work range setting switch for setting the allowable work range (for example, a prevention position setting switch 91 in the embodiment), and a work platform position detection device (for example, a vertical swing angle detector, an extension amount detector, and a control unit 30 in the embodiment) for detecting a height from the ground to the work platform and a horizontal distance as a turning radius from the turning center axis of the boom to the work platform at a current position of the work platform, wherein the designation device can designate the allowable work range by the height from the ground to the work platform and the horizontal distance which is the turning radius from the turning center axis of the boom to the work platform, which are detected by the work platform position detection device when the allowable work range setting switch is operated.

The operation control device for a vehicle with an aerial work platform described above preferably comprises a prevention release switch (for example, a prevention release switch 92 in the embodiment) for instructing release of an operation prevention of the boom. While the prevention release switch gives a release instruction, the operation prevention device releases the operation prevention of the boom. When the prevention release switch provides no release instruction, the operation prevention device prevents the operation of the boom.

The operation control device for a vehicle with an aerial work platform described above preferably comprises an alarm device. The operation control device generates an alarm sound when the operation prevention of the boom by the operation prevention device is released in response to a release instruction by the prevention release switch so that the operation control of the boom beyond the allowable work range is performed.

### Advantageous Effects of the Invention

According to an operation control device for a vehicle with an aerial work platform according to the present invention, when a designation device designates an allowable work range of a work platform, the operation preventing device prevents the operation of a boom by the operation control device based on an operation signal from the operation device so as not to exceed the designated allowable work range, whereby the operator can designate an allowable work range suitable for the worksite in accordance with the actual worksite situation.

In the operation control device for a vehicle with an aerial work platform described above, it is preferable that the designation device can designate the allowable work range by a height from the ground to the work platform and a horizontal distance which is a turning radius from the turning center axis of the boom to the work platform. Designating the allowable work range with a height and a horizontal distance eliminates the need to replace the allowable work range determined by the operator's actual visual observation of the worksite with the vertical swing angle or the amount of extension and contraction of the boom, facilitating the designation of the allowable work range.

The operation control device of a vehicle with an aerial work platform preferably comprises an allowable work range setting switch for setting the allowable work range and a work platform position detection device for detecting, at the current position of the work platform, a height from the ground to the work platform and a horizontal distance which is the turning radius from the turning center axis of the boom to the work platform, wherein the designation device is capable of designating the allowable work range by the height from the ground to the work platform and the horizontal distance which is the turning radius from the turning center axis of the boom to the work platform, which are detected by the work platform position detection device when the allowable work range setting switch is operated. Thus, the work platform can be moved to a position at a limit at which work can be performed safely, and the position can be designated within the allowable work range, so that the allowable work range can be designated more reliably.

The operation control device for a vehicle with an aerial work platform described above should preferably include a prevention release switch for instructing the release of the operation prevention of the boom. The prevention release switch releases the prevention of operation of the boom while the prevention release switch gives the release instruction. The prevention release device prevents the operation of the boom when the prevention release switch does not provide the release instruction. Thus, for example, in a case where the work platform does not reach the target position within the designated allowable work range, the work platform can be moved to the target position, allowing for flexible movement according to the situation of the worksite.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only and thus are not limitative of the present invention.

FIGS. 1A-1B A top view and a side view showing an appearance of a vehicle with an aerial work platform provided with an operation control device for the vehicle with an aerial work platform according to the present invention;

FIGS. 2A-2B A view showing an appearance of an upper operation device provided on a work platform of the same vehicle with an aerial work platform.

FIG. 3 A view showing a prevention range setting screen displayed on a touch panel of a lower operation device provided in a vehicle with an aerial work platform.

FIG. 4 A functional block diagram of one embodiment of an operation control device of a vehicle with an aerial work platform according to the present invention.

FIG. 5 An explanatory view for explaining an example of the allowable work range by the operation control device.

### DESCRIPTION OF THE EMBODIMENTS

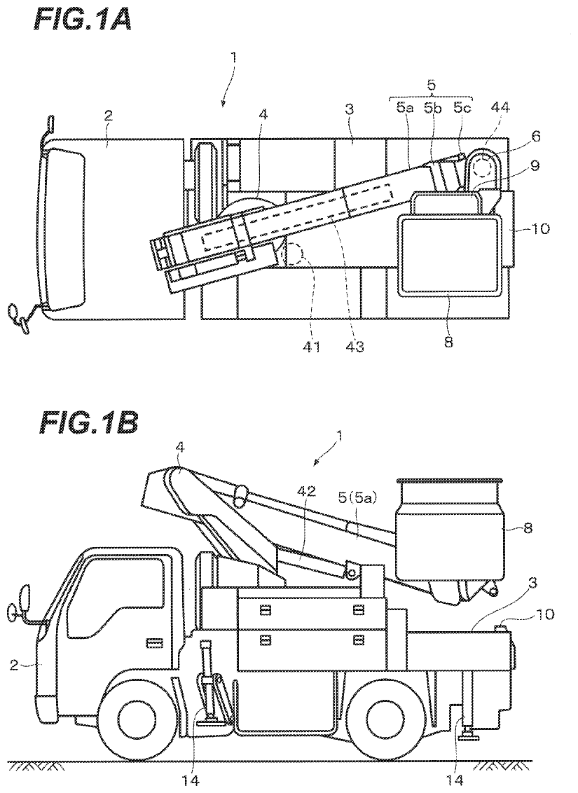

Hereinafter, an embodiment of the present invention will be described with reference to the drawings. An overall configuration of a vehicle with an aerial work platform equipped with an operation control device according to the present invention will be described with reference to FIGS. 1A-1B. FIG. 1A is a top view of the vehicle with an aerial work platform, and FIG. 1B is a left side view of the vehicle with an aerial work platform. The vehicle with an aerial work platform 1 is provided with a turntable 4 configured to be capable of horizontally rotatable with respect to the vehicle body 3 by the operation of a rotating motor 41 on the vehicle body 3 which has an operating cabin 2 and is configured to run freely, and a boom 5 is pivotably mounted on the upper portion of the turntable 4, swingable in a vertical plane with respect to the vehicle body 3 by the extension and contraction of a vertical swing cylinder 42.

The boom 5 comprises a base boom 5a pivotally mounted to the upper end portion of the turntable 4, an intermediate boom 5b, and a top boom 5c which are fitted into the base boom 5a in a telescopic manner in order so as to be slidable, and the boom 5 is mounted so as to be stretchable and movable by extending and retracting an axial extension cylinder 43 disposed inside the boom 5. A vertical post 6, which always maintains a vertical position regardless of the vertical swing angle of the boom 5 by the operation of a leveling cylinder (not shown), is disposed at the tip portion of the top boom 5c, and a work platform (also referred to as a bucket) 8 is mounted so as to be horizontally rotatable (referred to as a swing) around the vertical post 6 by the operation of a swing motor 44 disposed on the vertical post 6. In order to stably support the vehicle body 3 against a falling moment which acts on the vehicle body 3 to overturn the vehicle when the boom 5 is vertically swung or axially extended or retarcted, jacks 14, 14, are disposed at the front, rear, left and right sides of the vehicle body 3 to raise and support the vehicle body 3 by being extended based on the extension operation of the jack.

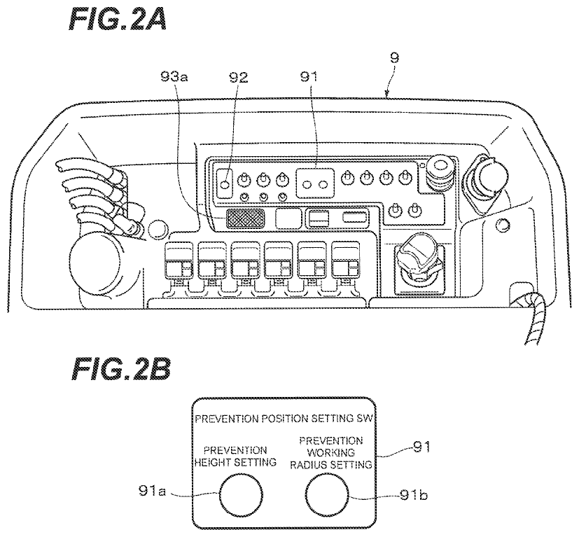

The work platform 8 is provided with an upper operation device 9 for operating the boom 5. The upper operation device 9 is provided with an operation lever for operating the boom 5, including the turntable 4, and is configured so that an operator on the work platform 8 can rotate the turntable 4 by operating the operation lever in the upper operation device 9, thereby allowing the boom 5 to be vertically swung, extended and contracted, and the work platform 8 to be swung, or the like. As shown in FIG. 2A, the upper operation device 9 is provided with a prevention position setting switch 91 for setting an allowable work range of the work platform 8, and a prevention release switch 92 for allowing movement of the work platform 8 beyond the allowable work range if necessary. Further, the upper operation device 9 is provided with a speaker 93a for outputting an alarm sound while the work platform 8 is moved beyond the permissible work range. The prevention position setting switch 91 and the prevention release switch 92 are push-button type switches, which are turned on while the button is pushed to a predetermined position against the force of a spring provided in the switch, and when the pushed button is released, the button is returned to its original position and turned off by the force of the spring. It should be noted that a toggle switch which automatically returns to the neutral position when the operation is stopped may be used as the prevention release switch 92 instead of the push-button type switch.

As shown in FIG. 2B, the prevention position setting switch 91 comprises a prevention height setting switch 91a and a prevention working radius setting switch 91b. The prevention height setting switch 91a is a switch for setting a limit position (also referred to as a “prevention height”) of the height above the ground (specifically, the distance from the ground to the lower surface of the work platform 8) at which the work platform 8 can move. When the prevention height setting switch 91a is turned on by an operator, or the like, the height of the work platform 8 at that time is set as the prevention height. The prevention working radius setting switch 91b is a switch for setting a limit position (also referred to as a “prevention working radius”) of the working radius (specifically, the horizontal distance from the rotational axis of the turntable 4 to the work platform 8) at which the work platform 8 can move. When the prevention working radius setting switch 91b is turned on by an operator, or the like, the position of the work platform 8 at that time (more precisely, the horizontal distance from the turning center axis of the turntable 4) is set as the prevention working radius. Either one of the prevention height or the prevention working radius can be set for setting the allowable work range, or both the prevention height and the prevention working radius can be set.

While the prevention release switch 92 is turned on by an operator, the work platform 8 can be moved beyond the set allowable work range in accordance with the operation of an operation lever provided on the upper operation device 9. While the work platform 8 is moved beyond the allowable work range and away from the allowable work range while the prevention release switch 92 is turned on, a warning sound is output from the speaker 93. When the prevention release switch 92 is turned off while the work platform 8 is moved beyond the allowable work range, the movement of the work platform 8 stops but the warning sound is continuously output. When the operation lever is operated while the prevention release switch 92 is kept off, the work platform 8 cannot be moved away from the allowable work range, but the work platform 8 can be moved toward the allowable work range.

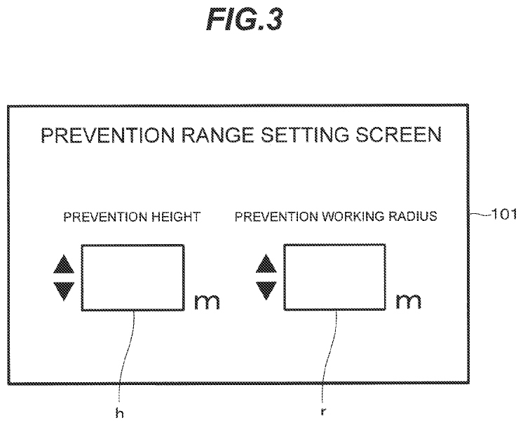

Referring back to FIGS. 1A-1B, a lower operation device 10 is provided at the rear end portion of the vehicle body 3. The lower operation device 10, like the upper operation device 9, is provided with an operation lever for operating the boom 5, including the turntable 4. By operating this operation lever, it is possible to control the rotating operation of the turntable 4, the vertically swinging operation and the extension and contraction operation of the boom 5, the swinging operation of the work platform 8, and the like, even from the ground. Further, the lower operation device 10 is provided with a touch panel 101, configured such that a prevention range setting screen as shown in FIG. 3 can be displayed. On the prevention range setting screen shown in FIG. 3, a prevention height display area h and a prevention working radius display area r are provided. When switching from another screen to the prevention range setting screen shown in FIG. 3, the prevention height display area h displays the currently set prevention height value (in meters) and the prevention working radius display area r displays the currently set prevention working radius value (in meters). In place of the touch panel, a monitor may be provided separately from a switch that enables switching of the display screen, increase/decrease of the numerical values displayed in the prevention height display area h and the prevention working radius display area r.

The “▴” and “▾” arrows for changing the values displayed in the respective display areas are displayed on the respective left sides of the prevention height display area h and the prevention working radius display area r. For example, when “▴” is displayed on the left side of the prevention height display area h is tapped, the values displayed in the prevention height display area h increase by a unit of 1 m each time the mark is tapped. When “▾” is tapped, the values displayed in the prevention height display area h decrease by a unit of 1 m each time the mark is tapped. Similarly, the numerical values displayed in the prevention working radius display area r can also be changed by tapping the “▴” and “▾” arrows. When the prevention range setting screen is switched to another screen, the values displayed in each display area at that time are stored as the set prevention height and the prevention working radius. When the prevention height display area h or the prevention working radius display area r is set to a predetermined value (for example, “0”), the specified value corresponding to that display area is handled as not being set.

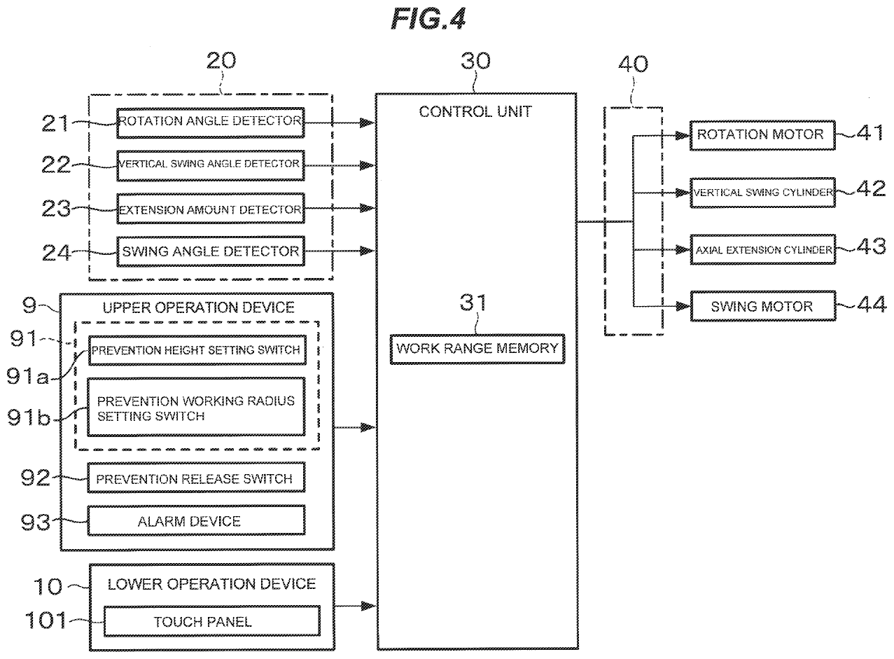

Next, an outline of the configuration of the operation control device according to the present embodiment will be described with reference to FIG. 4. The control unit 30 shown in this figure controls the operation of various actuators such as the above-mentioned rotation motor 41, the vertical swing cylinder 42, the axial extension cylinder 43, and the swing motor 44 based on the operation amount of the operation lever provided in the upper operation device 9 or the lower operation device 10. Thus, the operator can move the work platform 8 to a place to be a work object by operating the operation lever provided in the upper operation device 9 or the lower operation device 10. In this embodiment, the above-described various actuators are operated by hydraulic pressure. An electromagnetic proportional control valve corresponding to the above-described various actuators is provided in the hydraulic unit 40. The operation of the respective hydraulic actuators 41-44 is controlled by controlling the valve opening of the electromagnetic proportional control valve corresponding to the various hydraulic actuators by the control unit 30.

The detection value of the boom posture is also input to the control unit 30 from a boom position detection device 20 attached to the boom 5 and the turntable 4. The boom position detection device 20 includes a rotation angle detector 21 for detecting the rotation angle position of the turntable 4 with respect to the vehicle body 3, a vertical swing angle detector 22 for detecting the vertical swing angle of the boom 5, an extension amount detector 23 for detecting the extension amount of the boom 5, and the like. Detection data is output from these detectors and input to the control unit 30.

The control unit 30 has a work range memory 31 for storing a prevention height and a prevention working radius set by an operator. The prevention height and the prevention working radius stored in the work range memory 31 are set by the prevention height setting switch 91a and the prevention working radius setting switch 91b shown in FIG. 2B or by the prevention range setting screen shown in FIG. 3, and the values of the prevention height and the prevention working radius last set by these methods (the latest set values of the prevention height and the prevention working radius) are stored. In this embodiment, the prevention height and the prevention working radius are stored as numerical values indicating the length. Therefore, when the operator sets the prevention height and the prevention working radius by operating the prevention height setting switch 91a or the prevention working radius setting switch 91b, the control unit 30 calculates the height above the ground of the work platform 8 or the horizontal distance from the turning center axis of the turntable 4 on the basis of detection data (corresponding to the vertical swing angle of the boom 5 and the extension amount of the boom 5) from the vertical swing angle detector 22 and the extension amount detector 23 at that time, and stores the calculated horizontal distance in the work range memory 31.

A control unit 30 calculates the height above the ground (the distance from the ground to the lower surface of the work platform 8) and the working radius (the horizontal distance from the turning center axis of the turntable 4 to the work platform 8) of the work platform 8 based on the rotation angle of the turntable 4, the vertical swing angle of the boom 5, the extension amount of the boom 5, and the like, input from the detectors 21-23 of a boom position detection device 20, and compares the calculated height above the ground and the working radius of the work platform 8 with the prevention height and the prevention working radius stored in a work range memory 31. When it is determined that the calculated height above the ground or the working radius of the work platform 8 has reached the prevention height or the prevention working radius stored in the work range memory 31, movement of the work platform 8 in a direction exceeding the prevention height or the prevention working radius is prevented. For example, when work platform 8 has reached the prevention height, the control unit 30 prevents, from the position of the work platform 8, the operation of a vertical swing cylinder 42 such that the vertical swing angle of the boom 5 is increased, or the operation of an axial extension cylinder 43 such that the extension amount of the boom 5 is increased.

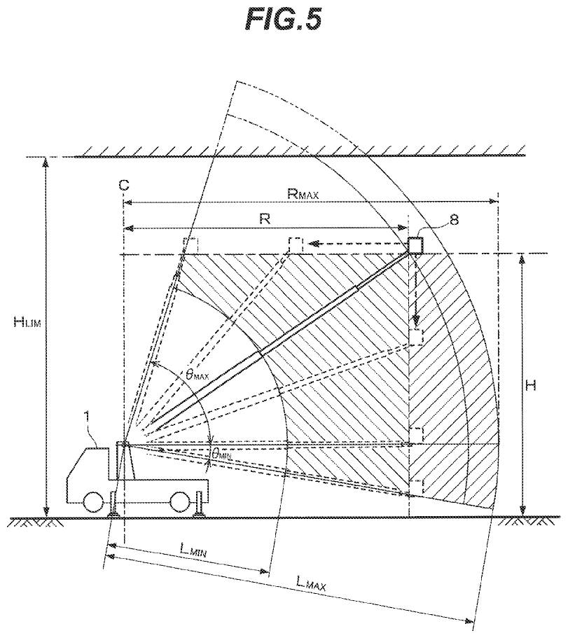

Next, an allowable work range in which the work platform 8 can be moved by the operation control device of the present embodiment when the operator sets the prevention height and the prevention working radius will be described with reference to the diagram shown in FIG. 5. In a vehicle with an aerial work platform 1 shown in FIG. 5, the maximum extension amount of the boom 5 is LMAX, the minimum extension amount is LMIN, the maximum elevation angle of the boom 5 is θ MAX, and the maximum depression angle is θ MIN. The maximum working radius of turntable 4 with respect to the turning center axis C is RMAX, where the turning center axis C is assumed to be perpendicular to the ground. The maximum elevation angle is an angle from a state in which the boom 5 is horizontal to a state in which it is maximally upright. The maximum depression angle is an angle from a state in which the boom 5 is horizontal to a state in which it is maximum down position. The maximum working radius RMAX is a length equal to the maximum extension amount LMAX when the vertical swing angle of the boom 5 is horizontal.

In the schematic diagram shown in FIG. 5, in a worksite where the upper limit of the height above the ground at which work can be performed is HLIM, the allowable work range in the case where the prevention height of the work platform 8 is set to H and the prevention working radius is set to R is indicated by hatching downward to the right. Hereinafter, the allowable work range indicated by hatching downward to the right is referred to as a first allowable work range. If the prevention height of the work platform 8 is set to H and the prevention working radius is not set (more precisely, a work range further extended from the first allowable work range described above) is indicated by hatching upward to the right. Hereinafter, the allowable work range obtained by combining the first allowable work range and the allowable work range indicated by hatching upward to the right is referred to as a second allowable work range.

As shown in FIG. 5, when the work platform 8 is located at a height H above the ground and at a working radius R, if an operator on the work platform 8 turns on both the prevention height setting switch 91a and the prevention working radius setting switch 91b (see FIGS. 2A-2B), the allowable work range of the work platform 8 becomes the first allowable work range. When the prevention height is set to H and the prevention working radius is set to R on the prevention range setting screen (see FIG. 3) displayed on the touch panel 101 of the lower operation device 10, the allowable work range of the work platform 8 becomes the first allowable work range.

In a state where the first allowable work range is set, when the work platform 8 is in the position indicated by the solid line in FIG. 5, it is assumed that the operator operates the operation lever so as to increase the elevation angle or the extension amount of the boom 5. In this case, since the height of the work platform 8 from the ground exceeds the first allowable work range, the control unit 30 controls the work platform 8 so as not to move from the position indicated by the solid line in FIG. 5 without operating the vertical swing cylinder 42 or the axial extension cylinder 43. When the operator operates the operation lever so as to decrease only the elevation angle of the boom 5, the working radius of the work platform 8 is beyond the allowable work range. Thus, the control unit 30 does not operate the vertical swing cylinder 42 or the axial extension cylinder 43, and controls so as not to move the work platform 8 from the position indicated by the solid line in FIG. 5

When the operator operates the operation lever so as to increase the elevation angle of the boom 5 from the position indicated by the solid line in FIG. 5, the control unit 30 may operate the axial extension cylinder 43 so as to decrease the extension amount of the boom 5 while operating the vertical swing cylinder 42 so as to increase the elevation angle of the boom 5, and control so that the work platform 8 moves vertically in the direction of the turning center axis C while maintaining the prevention height H as indicated by the arrow of the broken line in FIG. 5. When the operator operates the operation lever so as to increase the elevation angle of the boom 5 from the position indicated by the solid line in FIG. 5, control unit 30 may operate the axial extension cylinder 43 so as to decrease the extension amount of the boom 5 while operating the vertical swing cylinder 42 so as to decrease the elevation angle of the boom 5, and control so that the work platform 8 moves vertically in the downward direction while maintaining the working radius R as indicated by the arrow of the one-dot chain line in FIG. 5.

When the operator operates the operation lever while turning on the prevention release switch 92 shown in FIG. 2A, the work platform 8 can be moved beyond the first allowable work range. For example, when the operator operates the operation lever so as to increase the elevation angle or the extension amount of the boom 5 while turning on the prevention release switch 92 when the work platform 8 is in the position shown by the solid line in FIG. 5, the control unit 30 operates the vertical swing cylinder 42 or the axial extension cylinder 43 so as to increase the elevation angle or the extension amount of the boom 5 in accordance with the operation of the control unit 30. While work platform 8 moves beyond the first allowable work range, control unit 30 generates an alarm sound in the alarm device 93 and controls so that the alarm sound is output from the speaker 93a. When the operation amount of the operation lever is the same, the control unit 30 may control the operation of the vertical swing cylinder 42 or the axial extension cylinder 43 so that the moving speed of the work platform 8, when the work platform 8 is moving beyond the first allowable work range, is slower than the moving speed when the work platform 8 is moving within the first allowable work range.

When the operator turns off the prevention release switch 92 while the work platform 8 is moving beyond the first allowable work range, the control unit 30 stops the operation of the vertical swing cylinder 42 or the axial extension cylinder 43 to stop the movement of the work platform 8 even when the operation lever is being operated and controls the alarm device 93 so that an alarm sound is continuously generated. When the operator operates the operation lever in a direction to return the work platform 8 to the first allowable work range (for example, an operation to reduce the elevation angle of the boom 5 or an operation to reduce the extension amount of the boom 5), the control unit 30 may be configured to operate the vertical swing cylinder 42 or the axial extension cylinder 43 in response to the operation of the operation lever even when the prevention release switch 92 is off. Control unit 30 may also control the alarm device 93 so that the alarm sound continues to be generated until the work platform 8 returns to the first allowable work range.

Next, in FIG. 5, when the work platform 8 is located at a height H above the ground and at a working radius R when an operator on the work platform 8 turns on only the prevention height setting switch 91a, the allowable work range of the work platform 8 becomes the second allowable work range. In the prevention range setting screen (see FIG. 3) displayed on the touch panel 101 of the lower operation device 10, when the prevention height is set to H and the prevention working radius is set to a predetermined value (for example, “0”), the allowable work range of the work platform 8 becomes the second allowable work range.

Suppose that the operator operates the operation lever so as to increase the elevation angle or the amount of extension of the boom 5 when the work platform 8 is at the position indicated by the solid line in FIG. 5. In this case, since the height of the work platform 8 from the ground exceeds the second allowable work range, the control unit 30 controls the work platform 8 so as not to move from the position indicated by the solid line in FIG. 5 without operating vertical swing cylinder 42 or axial extension cylinder 43. On the other hand, when the operator operates the operation lever so as to decrease the angle of elevation of the boom 5, the work platform 8 moves within the second allowable work range so that the control unit 30 operates the vertical swing cylinder 42 so as to decrease the angle of elevation of the boom 5 in accordance with the amount of operation of the operation lever. At this time, it is also possible to increase the extension amount of the boom 5 within a range in which the work platform 8 does not exceed the second allowable work range.

Since the control of various actuators when the work platform 8 is moved beyond the second allowable work range and when the work platform 8 is returned from outside the second allowable work range to inside the second allowable work range is the same as that in the first allowable work range, a detailed description thereof will be omitted.

In the above-described embodiment, the prevention range setting screen (see FIG. 3) is displayed on the touch panel 101 provided in the lower operation device 10. The prevention height and the prevention working radius can be set by numerical values on the screen. However, the upper operation device 9 may also be provided with a touch panel to display a screen similar to the above-described prevention range setting screen. Then, the operator on work platform 8 can set the control height and the control working radius by numerical values. In the above-described embodiment, when the work platform 8 is moved beyond the allowable work range, it is necessary to continue to turn on the prevention release switch 92 (that is, the prevention release state is maintained only while the prevention release switch 92 is turned on), but once the prevention release switch 92 is turned on, the prevention release state is established so that the work platform 8 can be freely moved beyond the allowable work range even after the prevention release switch 92 is turned off.

As described above, the boom operation is prevented so as not to exceed the allowable work range when the work platform reaches the set allowable work range. However, when the work platform exceeds the allowable work range, the operation speed of the boom may be reduced so as to be slower than the previous operation speed. Further, as an example of a vehicle with an aerial work platform, a vehicle with an aerial work platform having tire wheels and capable of traveling and moving has been described, but the present invention is not limited to such a vehicle. For example, a vehicle with an aerial work platform having an iron wheel and traveling on a track or a vehicle with an aerial work platform with a crawler device capable of traveling and moving can be similarly configured to obtain similar effects.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

### RELATED APPLICATIONS

This invention claims the benefit of Japanese Patent Application No. 2020-167524 which is hereby incorporated by reference.

1. An operation control device for a vehicle with an aerial work platform, comprising:
a vehicle body;
a boom provided on the vehicle body so as to be capable of rotating, vertically swinging, and extending and contracting;
a work platform provided at the tip of the boom;
an operation device for operating the boom;
an operation control device for controlling rotating, vertically swinging, and extending and contracting the boom based on an operation signal from the operation device;
a designation device for designating an allowable work range of the work platform; and
an operation preventing device for preventing the operation of the boom by the operation control device so that the work platform does not exceed an allowable work range designated by the designation device.

2. The operation control device for a vehicle with an aerial work platform according to claim 1, wherein the designation device can designate the allowable work range by a height from the ground to the work platform and a horizontal distance which is a turning radius from a turning center axis of the boom to the work platform.

3. The operation control device according to claim 2 for a vehicle an aerial work platform, comprising:
an allowable work range setting switch for setting the allowable work range; and
a work platform position detection device for detecting a height from the ground to the work platform and a horizontal distance as a turning radius from the turning center axis of the boom to the work platform at a current position of the work platform;
wherein the designation device can designate the allowable work range by a height from the ground to the work platform and a horizontal distance which is a turning radius from the turning center axis of the boom to the work platform, which are detected by the work platform position detection device when the allowable work range setting switch is operated.

4. The operation control device for a vehicle with an aerial work platform according to claim 1, comprising a prevention release switch for instructing release of an operation prevention of the boom,
while the prevention release switch gives a release instruction, the operation prevention device releases the operation prevention of the boom,
when the prevention release switch provides no release instruction, the operation prevention device prevents the operation of the boom.

5. The operation control device for a vehicle with an aerial work platform according to claim 4, comprising:
an alarm device wherein the operation control device generates an alarm sound when the operation prevention of the boom by the operation prevention device is released in response to a release instruction by the prevention release switch so that the operation control of the boom beyond the allowable work range is performed.
